(19) United States
(12) Patent Application Publication
(10) Pub. No.: US 2026/0072996 A1
(43) Pub. Date: Mar. 12, 2026

(54) RESOURCE RECOMMENDATION METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventors: Shuyi XIE, Shenzhen (CN); Donglin ZHOU, Shenzhen (CN); Tianjiao LANG, Shenzhen (CN); Zhichao HU, Shenzhen (CN)

(21) Appl. No.: 19/338,035

(22) Filed: Sep. 24, 2025

Related U.S. Application Data
(63) Continuation of application No. PCT/CN2024/114790, filed on Aug. 27, 2024.

(30) Foreign Application Priority Data
Sep. 21, 2023 (CN) 202311221164.2

(51) Int. Cl. G06F 16/9535; G06F 16/3329

(52) U.S. Cl. CPC G06F 16/9535; G06F 16/3329

(57) ABSTRACT

A resource recommendation method includes constructing resource prompt information based on positive behavior information of a target object for a resource, the positive behavior information representing a positive behavior of the target object for a resource preference, and the resource prompt information representing a resource preferred by the target object; processing the resource prompt information by using a large language model, to obtain a resource text, the resource text being configured for describing the resource preference of the target object in a form of a natural language; determining, for any candidate resource in a resource library for recommendations, a correlation between the candidate resource and the resource text, the correlation representing a correlation between the resource preference of the target object and the candidate resource; and recommending a resource to the target object based on correlations corresponding to multiple candidate resources in the resource library.

### CROSS-REFERENCES TO RELATED APPLICATIONS

This application is a continuation application of PCT Patent Application No. PCT/CN2024/114790, filed on Aug. 27, 2024, which claims priority to Chinese Patent Application No. 2023112211642, filed on Sep. 21, 2023, all of which is incorporated herein by reference in their entirety.

### FIELD OF THE TECHNOLOGY

The present disclosure relates to the field of computer technologies, and in particular, to a resource recommendation method and apparatus, a computer device, and a storage medium.

### BACKGROUND OF THE DISCLOSURE

With the development of Internet technologies, resource recommendation scenarios have become commonplace. For example, meal recommendation scenarios on food delivery platforms, video recommendation scenarios on multimedia platforms, or clothing recommendation scenarios on shopping platforms. How to accurately recommend resources to users is a key focus of research in the field.

Currently, a commonly adopted approach is to leverage machine learning technologies, based on mining of massive user behaviors, to gain insights into users' interests and preferences, and then automatically generate personalized content recommendations for the users based on their interests and preferences.

### SUMMARY

One embodiment of the present disclosure provides a resource recommendation method performed by a computer device. The method includes constructing resource prompt information based on positive behavior information of a target object for a resource, the positive behavior information being configured for representing a positive behavior of the target object for a resource preference, and the resource prompt information being configured for representing a resource preferred by the target object; processing the resource prompt information by using a large language model, to obtain a resource text, the resource text being configured for describing the resource preference of the target object in a form of a natural language; determining, for any candidate resource in a resource library for recommendations, a correlation between the candidate resource and the resource text, the correlation being configured for representing a correlation between the resource preference of the target object and the candidate resource; and recommending a resource to the target object based on correlations corresponding to multiple candidate resources in the resource library.

Another embodiment of the present disclosure provides a computer device. The computer device includes one or more processors and a memory containing at least one computer program that, when being executed, causes the one or more processors to perform: constructing resource prompt information based on positive behavior information of a target object for a resource, the positive behavior information being configured for representing a positive behavior of the target object for a resource preference, and the resource prompt information being configured for representing a resource preferred by the target object; processing the resource prompt information by using a large language model, to obtain a resource text, the resource text being configured for describing the resource preference of the target object in a form of a natural language; determining, for any candidate resource in a resource library for recommendations, a correlation between the candidate resource and the resource text, the correlation being configured for representing a correlation between the resource preference of the target object and the candidate resource; and recommending a resource to the target object based on correlations corresponding to multiple candidate resources in the resource library.

Another embodiment of the present disclosure provides a non-transitory computer-readable storage medium containing at least one computer program that, when being executed, causes at least one processor to perform: constructing resource prompt information based on positive behavior information of a target object for a resource, the positive behavior information being configured for representing a positive behavior of the target object for a resource preference, and the resource prompt information being configured for representing a resource preferred by the target object; processing the resource prompt information by using a large language model, to obtain a resource text, the resource text being configured for describing the resource preference of the target object in a form of a natural language; determining, for any candidate resource in a resource library for recommendations, a correlation between the candidate resource and the resource text, the correlation being configured for representing a correlation between the resource preference of the target object and the candidate resource; and recommending a resource to the target object based on correlations corresponding to multiple candidate resources in the resource library.

### BRIEF DESCRIPTION OF THE DRAWINGS

To describe technical solutions of embodiments of the present disclosure more clearly, the following briefly introduces the accompanying drawings required for describing the embodiments. It is clear that the accompanying drawings in the following descriptions show only some embodiments of the present disclosure, and a person of ordinary skill in the art may still derive other drawings from these accompanying drawings without creative efforts.

FIG. 1 is a schematic diagram of an implementation environment of a resource recommendation method according to an embodiment of the present disclosure.

FIG. 2 is a flowchart of a resource recommendation method according to an embodiment of the present disclosure.

FIG. 3 is a flowchart of another resource recommendation method according to an embodiment of the present disclosure.

FIG. 4 is a block diagram of a resource recommendation apparatus according to an embodiment of the present disclosure.

FIG. 5 is a block diagram of another resource recommendation apparatus according to an embodiment of the present disclosure.

FIG. 6 is a structural block diagram of a terminal according to an embodiment of the present disclosure.

FIG. 7 is a schematic structural diagram of a server according to an embodiment of the present disclosure.

### DESCRIPTION OF EMBODIMENTS

To make the objectives, technical solutions, and advantages of the present disclosure clearer, the following further describes implementations of the present disclosure in detail with reference to the accompanying drawings.

In the present disclosure, the terms such as “first” and “second” are configured for distinguishing between same items or similar items with substantially same effects and functions. “First”, “second”, and “nth” do not have a dependency relationship in logic or a time sequence, and a quantity and an execution order are not limited.

In the present disclosure, the term “at least one” means one or more, and the term “plurality” means two or more.

Information (including but not limited to user equipment information, user personal information, and the like), data (including but not limited to data for analysis, data for storage, data for display, and the like), and signals involved in the present disclosure are all authorized by users or fully authorized by all parties, and collection, use, and processing of relevant data need to comply with relevant laws, regulations, and standards of relevant countries and regions. For example, resources and positive behavior information involved in the present disclosure are all obtained under full authorization.

When resource recommendation is performed, in a recommendation scenario including many small and medium-sized clients (for example, shops in mini programs that have only a few thousand recommendable resources and around 100,000 users), there is little resource information and sparse user behaviors, and a conventional resource recommendation model cannot learn fully, resulting in an inaccurate recommendation result.

In the solutions provided in embodiments of the present disclosure, a large language model can be trained based on machine learning technologies of artificial intelligence, and further a resource recommendation method is implemented by using a trained large language model, to accurately recommend a resource to a target object.

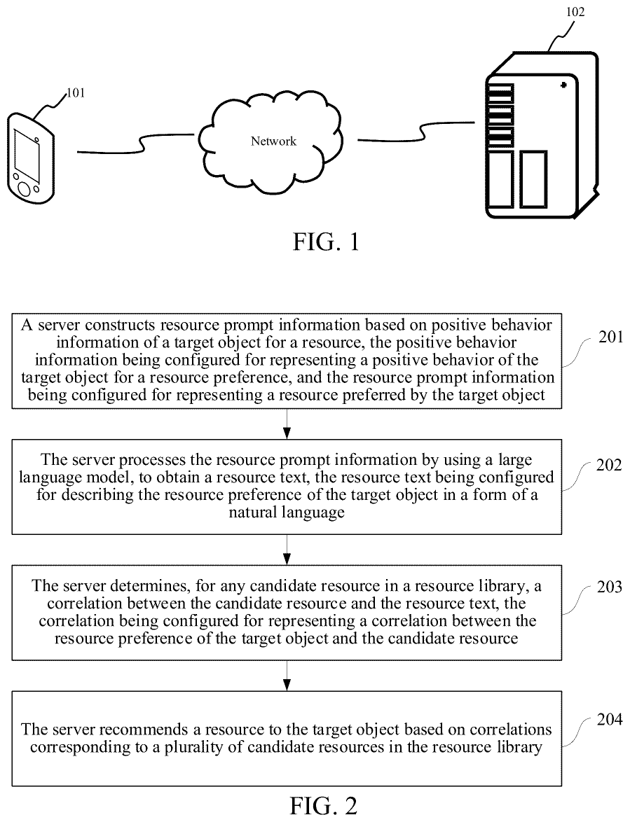

The resource recommendation method provided in the embodiments of the present disclosure can be performed by a computer device. In some embodiments, the computer device is a terminal or a server. An implementation environment of the resource recommendation method provided in the embodiments of the present disclosure is first described below by using an example in which the computer device is the server. FIG. 1 is a schematic diagram of an implementation environment of a resource recommendation method according to an embodiment of the present disclosure. Referring to FIG. 1, the implementation environment includes a terminal 101 and a server 102. The terminal 101 and the server 102 can be directly or indirectly connected in a wired or wireless communication manner. This is not limited in the present disclosure.

In some embodiments, the terminal 101 is a smartphone, a tablet, a notebook computer, a desktop computer, a smart speaker, a smartwatch, an intelligent voice interaction device, an intelligent household electrical appliance, a vehicle-mounted terminal, or the like, but is not limited thereto. An application program supporting a resource display is installed and run on the terminal 101. The application program may be a shopping application program, a multimedia application program, an instant messaging application program, a news information application program, or the like. This is not limited in the embodiments of the present disclosure. For example, the terminal 101 is a terminal used by a target object. The target object may use the terminal 101 to purchase resources such as food, clothes, and household goods, or may use the terminal 101 to watch multimedia resources such as videos and pictures. This is not limited in the embodiments of the present disclosure.

A person skilled in the art may know that there may be more or fewer terminals. For example, there may be only one terminal, or there may be dozens of or hundreds of terminals or more. A quantity of terminals and a device type are not limited in the embodiments of the present disclosure.

In some embodiments, the server 102 is an independent physical server, or may be a server cluster or a distributed system formed by a plurality of physical servers, or may be a cloud server that provides basic cloud computing services such as cloud services, cloud databases, cloud computing, cloud functions, cloud storage, network services, cloud communication, middleware services, domain name services, security services, content delivery networks (CDNs), big data, and artificial intelligence platforms. The server 102 is configured to provide a backend service for the application program supporting the resource display. The server 102 may recommend a resource to the target object based on a resource preference of the target object. To be specific, the server 102 may send information about the recommended resource to the terminal 101 based on the resource preference of the target object, so that the target object can obtain, through the terminal 101, a resource in which the target object is interested. In some embodiments, the server 102 is in charge of primary computing works, and the terminal 101 is in charge of secondary computing works. Alternatively, the server 102 is in charge of the secondary computing works, and the terminal 101 is in charge of the primary computing works. Alternatively, the server 102 and the terminal 101 perform collaborative computing by using a distributed computing architecture.

FIG. 2 is a flowchart of a resource recommendation method according to an embodiment of the present disclosure. Referring to FIG. 2, this embodiment of the present disclosure is described by using an example in which the method is performed by a server. The resource recommendation method includes the following operations:

201: The server constructs resource prompt information based on positive behavior information of a target object for a resource, the positive behavior information being configured for representing a positive behavior of the target object for a resource preference, and the resource prompt information being configured for representing a resource preferred by the target object.

In this embodiment of the present disclosure, the target object is a user. The resource may be a commodity resource such as food, clothes, or household goods, or may be a multimedia resource such as a video, an article, a picture, or audio. This is not limited in this embodiment of the present disclosure. The resource may also be referred to as a material. A preference of the target object for a resource may indicate that the target object is interested in the resource. Correspondingly, a positive behavior is a behavior that can reflect that the target object is interested in a resource. The server obtains the positive behavior information of the target object for the resource. The positive behavior information includes at least one positive behavior. Then, the server constructs the resource prompt information based on the positive behavior information. The resource prompt information is configured for guiding a large language model to understand the resource preference of the target object. The positive behavior information of the target object for the resource may be provided by the target object, or may be provided by a provider of the resource. This is not limited in this embodiment of the present disclosure.

202: The server processes the resource prompt information by using the large language model, to obtain a resource text, the resource text being configured for describing the resource preference of the target object in a form of a natural language.

In this embodiment of the present disclosure, the large language model may be a chat general language model (ChatGLM) or large language model meta artificial intelligence (LLaMa). This is not limited in this embodiment of the present disclosure. The server inputs the resource prompt information into the large language model, and processes the resource prompt information by using the large language model, to obtain the resource text. That is, the server understands the resource preference of the target object by using the large language model, and describes the resource preference in the form of the natural language.

203: The server determines, for any candidate resource (e.g., any resource to be recommended) in a resource library, a correlation between the candidate resource and the resource text, the correlation being configured for representing a correlation between the resource preference of the target object and the candidate resource.

In this embodiment of the present disclosure, the resource library includes a plurality of candidate resources. The resource library may be deployed in a current server or in another server. This is not limited in this embodiment of the present disclosure. The server calculates a correlation between each candidate resource in the resource library and the resource text by using the large language model. That is, the server compares each candidate resource in the resource library with the resource preference of the target object, to determine whether the candidate resource is in line with the resource preference of the target object.

204: The server recommends a resource to the target object based on correlations corresponding to the plurality of candidate resources in the resource library.

In this embodiment of the present disclosure, the server may recommend, to the target object, a plurality of candidate resources in the resource library that correspond to high correlations. The “high correlation” means that the correlation reaches a threshold, or means a preset quantity of top-ranked correlations sorted in descending order. This is not limited in this embodiment of the present disclosure.

This embodiment of the present disclosure provides a resource recommendation method. Because positive behavior information of a target object for a resource can reflect a resource preferred by the target object, resource prompt information is constructed by using the positive behavior information, so that the resource prompt information can accurately describe a resource preference of the target object. Then, the resource prompt information is processed by using a large language model. Because the large language model has rich corpus knowledge, a resource text obtained by using the large language model can more accurately describe the resource preference of the target object. Then, a correlation between the resource text and a candidate resource in a resource library is calculated, and a resource is recommended to the target object based on a correlation between the candidate resource and the resource preference of the target object, so that the recommended resource is in line with the resource preference of the target object, thereby improving accuracy of resource recommendation.

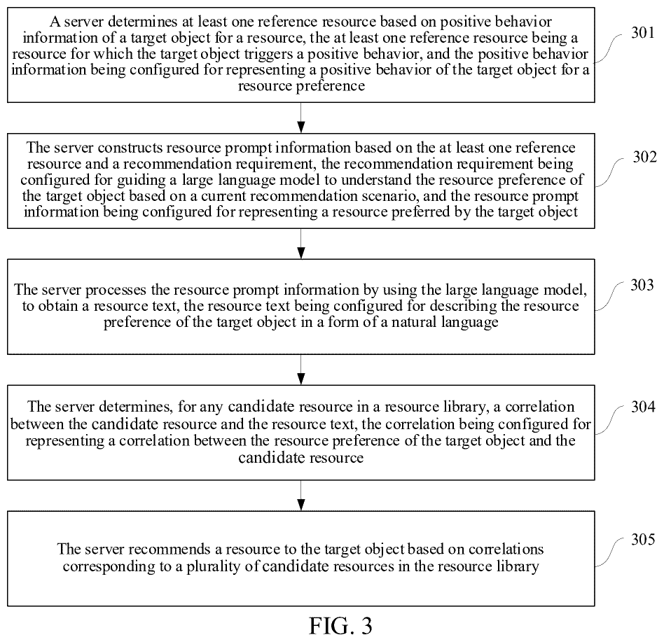

FIG. 3 is a flowchart of another resource recommendation method according to an embodiment of the present disclosure. Referring to FIG. 3, this embodiment of the present disclosure is described by using an example in which the method is performed by a server. The resource recommendation method includes the following operations:

301: The server determines at least one reference resource based on positive behavior information of a target object for a resource, the at least one reference resource being a resource for which the target object triggers a positive behavior, and the positive behavior information being configured for representing a positive behavior of the target object for a resource preference.

In this embodiment of the present disclosure, the positive behavior of the target object for the resource is configured for representing that the target object is interested in the resource. The resource is in line with the resource preference of the target object. The resource may be a commodity resource such as food, clothes, or household goods. Correspondingly, the positive behavior may be a clicking/tapping behavior, a purchasing behavior, a favoriting behavior, a sharing behavior, or the like. The resource may alternatively be a multimedia resource such as a video, an article, a picture, or audio. Correspondingly, the positive behavior may be a clicking/tapping behavior, a liking behavior, a favoriting behavior, a positive comment behavior, a sharing behavior, or the like. This is not limited in this embodiment of the present disclosure. The server obtains the positive behavior information of the target object for the resource. The positive behavior information includes at least one positive behavior of the target object. The positive behavior in the positive behavior information may be triggered by the target object in a preset time period. This is not limited in this embodiment of the present disclosure.

For example, the resource is the food. In the last week, the positive behavior information of the target object for the resource includes positive behaviors such as two purchasing behaviors and one clicking/tapping behavior (no purchase). The target object separately purchases the Chaoshan beef kway teow and the shrimp rice roll, and clicks/taps to view only the beef and egg noodles. Then, the server determines, based on the foregoing positive behavior information, that three reference resources are respectively the Chaoshan beef kway teow, the shrimp rice roll, and the beef and egg noodles.

Alternatively, the resource is the video. In the last week, the positive behavior information of the target object for the resource includes 100 clicking/tapping behaviors (clicking/tapping only) and 25 liking behaviors (clicking/tapping+liking). Then, the server may determine, based on the foregoing positive behavior information, 100 resources on which the clicking/tapping behaviors are performed as reference resources, or determine 25 resources on which the liking behaviors are performed as reference resources. This is not limited in this embodiment of the present disclosure.

The server may determine the reference resource based on a recommendation indicator of the resource. The recommendation indicator is configured for indicating a standard to be met by a reference resource for recommendation. The recommendation indicator is not limited in this embodiment of the present disclosure. For example, the recommendation indicator includes a first-level indicator, a second-level indicator, and a third-level indicator. The first-level indicator is that there is a clicking/tapping behavior. The second-level indicator is that there is a favoriting behavior (clicking/tapping+favoriting) or a liking behavior (clicking/tapping+liking). The third-level indicator is that there is a purchasing behavior (clicking/tapping+favoriting+purchasing).

302: The server constructs resource prompt information based on the at least one reference resource and a recommendation requirement, the recommendation requirement being configured for guiding a large language model to understand the resource preference of the target object based on a current recommendation scenario, and the resource prompt information being configured for representing a resource preferred by the target object.

In this embodiment of the present disclosure, the server obtains the recommendation requirement. The recommendation requirement is a requirement to be met for recommending a resource in the current recommendation scenario, and may guide the large language model to understand a recommendation task to be executed. The recommendation requirement may include a resource recommendation scenario, a quantity of resources required for resource recommendation, a resource type required for resource recommendation, or the like. This is not limited in this embodiment of the present disclosure. The server constructs the resource prompt information based on the at least one reference resource and the recommendation requirement. The at least one reference resource may be considered as user behavior information injection. The recommendation requirement may be considered as role injection. The recommendation requirement means making the large language model understand recommendation task descriptions, and generate corresponding text information based on the current recommendation scenario. In some embodiments, the resource prompt information may be constructed by concatenating the recommendation requirement and the at least one reference resource. In the solution provided in this embodiment of the present disclosure, the positive behavior of the target object for the reference resource can reflect the resource preference of the target object for the resource, and the recommendation requirement can reflect the requirement to be met for recommending the resource in the current recommendation scenario. Therefore, the resource prompt information is constructed by using the reference resource and the recommendation requirement, so that the resource prompt information not only can accurately represent the resource preference of the target object, but also can guide the large language model to accurately understand the resource preference of the target object in a subsequent process, thereby facilitating more accurately recommending a resource to the target object.

For example, resource prompt information is “You are a recommendation system oriented to small and medium-sized scenarios. I will tell you consumption behavior information of the target object. Please mine potential preferences of the target object and generate language descriptions. Please pay attention to accuracy and diversity of a recommendation result. Resource sequences recently clicked/tapped by the target object are the Chaoshan beef kway teow, the shrimp rice roll, and the beef and egg noodles. Please generate preference descriptions of the target object at a next moment”. “You are a recommendation system oriented to small and medium-sized scenarios. I will tell you consumption behavior information of the target object. Please mine potential preferences of the target object and generate language descriptions” is a recommendation requirement, and can subsequently guide the large language model to understand a recommendation task, and generate text information based on the requirement. “Resource sequences recently clicked/tapped by the target object are the Chaoshan beef kway teow, the shrimp rice roll, and the beef and egg noodles. Please generate preference descriptions of the target object at a next moment” is at least one reference resource, and can subsequently guide the large language model to summarize and mine the resource preference of the target object, and generate a natural language for describing the resource preference. The “small and medium-sized scenarios” are recommendation scenarios having small scales, little resource information, and sparse user behaviors. For example, shops in mini programs have only a few thousand recommendable resources and around 100,000 users.

303: The server processes the resource prompt information by using the large language model, to obtain a resource text, the resource text being configured for describing the resource preference of the target object in a form of a natural language.

In this embodiment of the present disclosure, the server inputs the resource prompt information into the large language model. Then, the server analyzes the resource prompt information by using the large language model, to obtain the resource text. That is, the server understands the resource preference of the target object by using the large language model, and describes the resource preference in the form of the natural language.

In some embodiments, the server obtains, through analysis based on the resource prompt information, a resource type preferred by the target object, to subsequently recommend a resource based on the resource type preferred by the target object. Correspondingly, a process in which the server processes the resource prompt information by using the large language model, to obtain the resource text includes: The server analyzes the resource prompt information by using the large language model, to determine a target resource type preferred by the target object. Then, the server obtains at least one resource type related to the target resource type. Then, the server generates the resource text based on the target resource type and the at least one resource type. When the resource text is generated based on the target resource type and the at least one related resource type, a first resource text corresponding to the target resource type is generated based on the target resource type, a second resource text corresponding to the at least one related resource type is generated based on the at least one related resource type, and the first resource text and the second resource text are concatenated, to obtain the resource text. In the solution provided in this embodiment of the present disclosure, because the large language model has rich corpus knowledge, the resource prompt information is analyzed by using the large language model, to accurately determine the resource type preferred by the target object, so that a subsequently recommended resource is in line with the resource preference of the target object, thereby improving accuracy of resource recommendation. In addition, the resource text is generated by using the at least one resource type related to the target resource type. This facilitates recommending a plurality of types of resources to the target object while ensuring the recommendation accuracy, thereby improving diversity of the resource recommendation.

In a process of obtaining the at least one resource type related to the target resource type, the server may obtain the resource type related to the target resource type in at least one of the following manners.

First manner: The server obtains, from the current recommendation scenario based on a correlation relationship between resource types, the at least one resource type related to the target resource type. The current recommendation scenario may be a food recommendation scenario, a clothes recommendation scenario, or a multimedia resource recommendation scenario. This is not limited in this embodiment of the present disclosure. The method is equivalent to recommending a resource to the target object on a current resource platform based on a resource preference of the target object on the current resource platform. In the solution provided in this embodiment of the present disclosure, resources of a plurality of resource types in the current recommendation scenario can be recommended to the target object. This improves diversity of resource recommendation in the current recommendation scenario while ensuring recommendation accuracy.

The correlation relationship between the resource types is not limited in this embodiment of the present disclosure. The correlation relationship between the resource types may be determined based on resources. The following uses different resources as an example, to exemplarily describe the correlation relationship between the resource types, but this is not limited thereto.

First, the resource is food. The resource type may be Sichuan cuisine, Hunan cuisine, or cooked wheaten food. Correspondingly, the correlation relationship between the resource types may be a taste relationship or a regional relationship. This is not limited in this embodiment of the present disclosure. If the target resource type preferred by the target object is the Sichuan cuisine, and the server may obtain, through analysis by using the large language model, that the target object generally prefers spicy food, the server obtains the Hunan cuisine with generally spicy food based on a taste relationship between resource types, and uses the Hunan cuisine as a resource type related to the target resource type. If the target resource type preferred by the target object is Cantonese cuisine, and the server may obtain, through analysis by using the large language model, a geographical location of food preferred by the target object, the server obtains Fujian cuisine in a close geographical location based on a location relationship between resource types, and uses the Fujian cuisine as a resource type related to the target resource type.

For example, resource prompt information inputted by the server into the large language model is “You are a recommendation system oriented to small and medium-sized scenarios. I will tell you consumption behavior information of the target object. Please mine potential preferences of the target object and generate language descriptions. Please pay attention to accuracy and diversity of a recommendation result. Resource sequences recently clicked/tapped by the target object are the Chaoshan beef kway teow, the shrimp rice roll, and the beef and egg noodles. Please generate preference descriptions of the target object at a next moment”. The server analyzes the resource prompt information by using the large language model, and an obtained resource text is “Based on the latest clicking/tapping behaviors of the target object, it can be seen that the target object is interested in the Cantonese cuisine and the cooked wheaten food. That is, the target object may like Chaoshan cuisine in the Cantonese cuisine and the cooked wheaten food, for example, Guangdong special snacks, Cantonese delicious food, and various types of cooked wheaten food. In addition, the target object may also be interested in delicious food in other places, for example, the Sichuan cuisine, the Hunan cuisine, and Northeastern Chinese cuisine”. The “Chaoshan cuisine and cooked wheaten food” are target resource types preferred by the target object. The “Sichuan cuisine, Hunan cuisine, and Northeastern Chinese cuisine” are resource types related to the target resource types. “Based on the latest clicking/tapping behaviors of the target object, it can be seen that the target object is interested in the Cantonese cuisine and the cooked wheaten food. That is, the target object may like Chaoshan cuisine in the Cantonese cuisine and the cooked wheaten food, for example, Guangdong special snacks, Cantonese delicious food, and various types of cooked wheaten food” is a first resource text corresponding to the target resource types. “In addition, the target object may also be interested in delicious food in other places, for example, the Sichuan cuisine, the Hunan cuisine, and Northeastern Chinese cuisine” is a second resource text corresponding to at least one related resource type.

Second, the resource is clothes. The resource type may be tops, trousers, dresses, hats, or the like. Correspondingly, the correlation relationship between the resource types may be a color relationship, a seasonal relationship, a material relationship, or the like. This is not limited in this embodiment of the present disclosure. If the target resource type preferred by the target object is the tops, and the server may obtain, through analysis by using the large language model, colors preferred by the target object, the server obtains, based on a color relationship between resource types, trousers or hats matching the colors of the tops, and uses the trousers or the hats as a resource type related to the target resource type. If the target resource type preferred by the target object is shorts, and the server may obtain, through analysis by using the large language model, that the clothes preferred by the target object are for the summer, the server obtains, based on a seasonal relationship between resource types, tops such as T-shirts matching the season corresponding to the shorts, and uses the tops as a resource type related to the target resource type.

For example, resource prompt information inputted by the server into the large language model is “You are a recommendation system oriented to small and medium-sized scenarios. I will tell you consumption behavior information of the target object. Please mine potential preferences of the target object and generate language descriptions. Please pay attention to accuracy and diversity of a recommendation result. Resource sequences recently purchased by the target object are the T-shirt, sun-protective clothing, and a shirt. Please generate preference descriptions of the target object at a next moment”. The server analyzes the resource prompt information by using the large language model, and an obtained resource text is “Based on the latest clicking/tapping behaviors of the target object, it can be seen that the target object is interested in the tops. That is, the target object may like tops suitable for summer wear. In addition, the target object may also be interested in other clothes suitable for summer wear, for example, the shorts or skirts”. The “tops” are a target resource type preferred by the target object. The “shorts or skirts” are a resource type related to the target resource type. “Based on the latest clicking/tapping behaviors of the target object, it can be seen that the target object is interested in the tops. That is, the target object may like tops suitable for summer wear” is a first resource text corresponding to the target resource type. “In addition, the target object may also be interested in other clothes suitable for summer wear, for example, the shorts or skirts” is a second resource text corresponding to at least one related resource type.

Third, the resource is a multimedia resource such as a video. The resource type may include a plurality of style types such as an explanation type, a funny type, and a documentary type. This is not limited in this embodiment of the present disclosure. If the target resource type preferred by the target object is the explanation type, and the server may obtain, through analysis by using the large language model, explanation content preferred by the target object, the server obtains, based on a content relationship between resource types, the documentary type having same explanation content, and uses the documentary type as a resource type related to the target resource type.

For example, resource prompt information inputted by the server into the large language model is “You are a recommendation system oriented to small and medium-sized scenarios. I will tell you clicking/tapping behavior information of the target object. Please mine potential preferences of the target object and generate language descriptions. Please pay attention to accuracy and diversity of a recommendation result. Resource sequences recently clicked/tapped by the target object are an explanation video of a movie 1, an explanation video of a movie 2, and an explanation video of a movie 3. Please generate preference descriptions of the target object at a next moment”. The server analyzes the resource prompt information by using the large language model, and an obtained resource text is “Based on the latest clicking/tapping behaviors of the target object, it can be seen that the target object is interested in the explanation type. That is, the target object may like a video explaining a movie. In addition, the target object may also be interested in another movie-related video, for example, a documentary video of a movie”. The “explanation type” is a target resource type preferred by the target object. The “documentary video of a movie” is a resource type related to the target resource type. “Based on the latest clicking/tapping behaviors of the target object, it can be seen that the target object is interested in the explanation type. That is, the target object may like a video explaining a movie” is a first resource text corresponding to the target resource type. “In addition, the target object may also be interested in another movie-related video, for example, a documentary video of a movie” is a second resource text corresponding to at least one related resource type.

Second manner: The server determines, based on another recommendation scenario related to the current recommendation scenario, a resource preference of the target object in the another recommendation scenario. Then, the server obtains, from the current recommendation scenario based on the resource preference of the target object in the another recommendation scenario, the at least one resource type related to the target resource type. Types of resources recommended in the another recommendation scenario and the current recommendation scenario may be the same or may be different. This is not limited in this embodiment of the present disclosure. A provider of a resource in the another recommendation scenario may be the same as or different from a provider of a resource in the current recommendation scenario. In the solution provided in this embodiment of the present disclosure, a plurality of recommendation scenarios share one large language model to implement resource recommendation. This greatly reduces resource recommendation costs, and can recommend resources of a plurality of resource types to the target object in a cross-scenario case, thereby improving diversity of the resource recommendation while ensuring recommendation accuracy.

For example, types of resources recommended in the another recommendation scenario and the current recommendation scenario are the same. The another recommendation scenario and the current recommendation scenario are both configured for recommending food. Correspondingly, the server obtains, from the current recommendation scenario based on a food type preferred by the target object in the another recommendation scenario, at least one food type related to the food type, to subsequently recommend food of the food type and food of the at least one food type related to the food type to the target object. The method is equivalent to recommending a resource to the target object on a current resource platform based on a resource preference of the target object on another resource platform of the same type.

Alternatively, types of resources recommended in the another recommendation scenario and the current recommendation scenario are different. The another recommendation scenario is configured for recommending household goods, and the current recommendation scenario is configured for recommending food. Correspondingly, the server obtains, from the current recommendation scenario based on a type of household goods preferred by the target object in the another recommendation scenario, at least one food type related to the type of the household goods, to subsequently recommend food of the at least one food type related to the type of the household goods to the target object. For example, the type of the household goods preferred by the target object in the another recommendation scenario is baby products. Correspondingly, the server obtains, from the current recommendation scenario, at least one food type suitable for a baby, to subsequently recommend food suitable for the baby to the target object. The method is equivalent to recommending a resource to the target object on a current resource platform based on a resource preference of the target object on another resource platform of a different type.

304: The server determines, for any candidate resource in a resource library, a correlation between the candidate resource and the resource text, the correlation being configured for representing a correlation between the resource preference of the target object and the candidate resource.

In this embodiment of the present disclosure, the large language model includes a recommendation task layer. The server compares each candidate resource in the resource library with the resource preference of the target object by using the recommendation task layer in the large language model, to determine whether the candidate resource is in line with the resource preference of the target object. That is, the server calculates a correlation between each candidate resource in the resource library and the resource text by using the large language model, to determine whether the candidate resource is in line with the resource preference of the target object.

In some embodiments, the correlation between the candidate resource and the resource text is a similarity between the candidate resource and the resource text. Correspondingly, a process in which the server determines the correlation between the candidate resource and the resource text includes: The server performs, for the any candidate resource in the resource library, feature extraction on the candidate resource based on the large language model, to obtain a resource feature of the candidate resource. The resource feature is configured for representing detailed information of the candidate resource. Then, the server performs feature extraction on the resource text based on the large language model, to obtain a resource text feature. Then, the server determines a similarity between the resource feature of the candidate resource and the resource text feature. The similarity is the correlation between the resource preference of the target object and the candidate resource. A higher similarity indicates that a corresponding candidate resource is more in line with the resource preference of the target object. In the solution provided in this embodiment of the present disclosure, the similarity between the resource feature of the candidate resource and the resource text feature is calculated, to more accurately determine whether the candidate resource is in line with the resource preference of the target object, thereby facilitating more accurate resource recommendation subsequently.

In some embodiments, the resource feature of the candidate resource and the resource text feature may be d-dimensional feature vectors. The server may calculate the similarity between the resource feature of the candidate resource and the resource text feature according to the following formula 1.

$${r}_{i , t} = {v}_{p} {m}_{i}^{T} . \qquad Formula 1$$

i is configured for representing a number of the candidate resource in the resource library; mᵢ is configured for representing a resource feature of an i^{th} candidate resource, where mᵢ∈R^{1×d}; d is configured for representing a feature dimension; T is configured for representing transposition; vₚ is configured for representing the resource text feature, where v_{p∈R}^{1×d}; d is configured for representing a feature dimension; and r_{i,t} is configured for representing a similarity between the resource feature of the i^{th} candidate resource and the resource text feature, and is configured for recommending the i^{th} candidate resource at a t^{th} moment (next moment), to prompt the target object to trigger a positive behavior for the i^{th} candidate resource.

In a process of obtaining the resource feature of the candidate resource, for the any candidate resource in the resource library, the server obtains text information of the candidate resource. Then, the server performs feature extraction on the text information based on the large language model, to obtain the resource feature of the candidate resource. That is, the server encodes the text information of the candidate resource based on the large language model, to obtain the resource feature of the candidate resource. The text information is the detailed information of the candidate resource. The text information may include at least one type of information such as a resource name, a resource type, resource content, and a resource tag. The resource tag may be configured for indicating a consumption manner carried in the resource, the resource type, or the like. This is not limited in this embodiment of the present disclosure. In the solution provided in this embodiment of the present disclosure, feature processing is performed on the text information of the candidate resource by using the rich corpus knowledge possessed by the large language model, to improve accuracy of the resource text, that is, to accurately describe the resource preference of the target object. This facilitates subsequently more accurately recommending a resource to the target object.

The server may store the resource feature of the candidate resource in the resource library. The resource library may be Faiss. This is not limited in this embodiment of the present disclosure. Then, the server may further establish an index of the candidate resource in the resource library, so that the resource library can be searched for the resource based on the index subsequently.

305: The server recommends a resource to the target object based on correlations corresponding to a plurality of candidate resources in the resource library.

In this embodiment of the present disclosure, the server may recommend, to the target object, a plurality of candidate resources in the resource library that correspond to high correlations. That is, the server may recommend a plurality of candidate resources whose correlations reach a preset value to the target object. Alternatively, the server may recommend, to the target object, a preset quantity of top-ranked candidate resources sorted in descending order of the correlations. In other words, the server may use the resource text feature of the target object as query information, and retrieve a preset quantity of resource features most similar to the resource text feature from the resource library (for example, Faiss). Then, the server outputs, by using the large language model, indexes and correlations that correspond to the preset quantity of resource features. Then, the server recommends, to the target object, candidate resources indicated by the indexes. This is not limited in this embodiment of the present disclosure. In comparison with a conventional recommendation system, in this solution, end-to-end recommendation is implemented based on the large language model. Only the positive behavior information of the target object needs to be inputted into the large language model, so that accurate resource recommendation can be implemented, and a complex event tracking design is not needed, thereby optimizing a model design procedure, and reducing deployment costs of the resource recommendation.

In some embodiments, the server recommends, to the target object, the preset quantity of top-ranked candidate resources sorted in descending order of the correlations. Correspondingly, a process in which the server recommends the resource to the target object based on the correlations corresponding to the plurality of candidate resources in the resource library includes: The server sorts the plurality of candidate resources in the resource library in descending order of the correlations. Then, the server recommends the preset quantity of top-ranked candidate resources to the target object. In the solution provided in this embodiment of the present disclosure, the plurality of candidate resources having high correlations are recommended to the target object, to ensure that the recommended resources are in line with the resource preference of the target object, thereby improving accuracy of resource recommendation.

There is a gap between a training task and the recommendation task of the large language model, and the large language model is not specially trained by using a data set of the recommendation task. Therefore, directly using the large language model for recommendation may limit recommendation performance of the large language model. The “training task” means training the large language model based on a large quantity of common language texts, to enable the large language model to have performance of understanding text semantics. The “recommendation task” means training the large language model based on resource information and object behavior information, to enable the large language model to have performance of recommending a resource to an object. In some embodiments, before performing resource recommendation, the server may train the large language model based on the recommendation task. Correspondingly, a training process of the large language model includes: The server constructs sample prompt information based on positive behavior information of a sample object for a resource. The positive behavior information is configured for representing a positive behavior of the sample object for a resource preference. The sample prompt information is configured for representing a resource preferred by the sample object. Then, the server processes the sample prompt information by using the large language model, to obtain a sample resource text. The sample resource text is configured for describing the resource preference of the sample object in a form of a natural language. Then, the server determines a predictive recommendation result based on the sample resource text. The predictive recommendation result is configured for representing a resource predicted by the large language model for recommendation to the sample object. Then, the server trains the large language model based on the predictive recommendation result and a reference recommendation result. The reference recommendation result is configured for representing a resource recommended to the sample object under real circumstance. In the solution provided in this embodiment of the present disclosure, the large language model is trained by using the resource recommended to the sample object in under the real circumstance and the resource predicted by the large language model, to effectively improve a generalization capability of the large language model in the recommendation task, thereby facilitating improving accuracy of resource recommendation of the large language model.

The server may first obtain the large language model obtained through training based on a language text. The large language model obtained through training based on the language text has rich corpus knowledge. Then, the server keeps a parameter of the large language model unchanged, and adds an adjustable parameter to the large language model. Then, the server adjusts the adjustable parameter of the large language model, to minimize a difference between the predictive recommendation result and the reference recommendation result.

In some embodiments, the server may determine the parameter of the large language model according to the following formula 2.

$${W}_{0} + Δ W = {W}_{0} + BA , B ∈ {R}^{d \times r} ; A ∈ {R}^{r \times k} . \qquad Formula 2$$

d, r, and k are configured for representing dimensions, and r<<min (d, k); W₀ is configured for representing an original parameter of the large language model, namely, a model parameter obtained through training based on a language text; ΔW is configured for representing the adjustable parameter of the large language model, where ΔW=BA; and A and B are configured for representing parameter matrices. In a model training process, the server keeps the original parameter W₀ of the large language model frozen, no update needs to be performed, and only the parameter matrices A and B need to be trained. Before model training, the server may use random Gaussian distribution to initialize the parameter matrix A, and set the parameter matrix B to an all-zero matrix, so as to ensure that a matrix BA is an all-zero matrix before training. In an initial case, an output of the large language model is h=W₀x. x is configured for representing a model input. After the parameter is updated, an output of the model is h=W₀x+ΔWx=W₀x+BAx.

The foregoing training manner may be considered as a low-rank adaptation (LoRA) fine tuning manner. The LoRA fine tuning manner means freezing an original parameter in a pre-trained model, and introducing a trainable low-rank decomposition matrix (also referred to as a bypass matrix) to each layer in a Transformer architecture. During fine tuning, only the bypass matrix (BA) needs to be updated. In this manner, the low-rank decomposition matrix is optimized, so that information about a downstream recommendation task can be effectively added to the large language model when the original model structure parameter is frozen, and a model parameter updated in a training process of this manner is only approximately one thousandth of original large language model parameters. In comparison with updating all the original model parameters of the large language model, fewer parameters are adjusted in the foregoing training manner. The training manner is a lightweight and fine-tuned training manner, and can improve training efficiency. The generalization capability of the large language model in the recommendation task can be effectively improved through LoRA fine tuning. In this solution, a plurality of small and medium-sized clients may share the same large-scale language model, to effectively reduce costs. With the increase of access clients, material knowledge of the large language model can be effectively reused, a model fine tuning effect is better, and a model recommendation capability is improved accordingly.

In some embodiments, before the foregoing model fine tuning is performed, the server inputs the sample prompt information into the large language model, to obtain the sample resource text. Then, the server corrects the sample resource text. Then, the server uses the sample prompt information and a corrected sample resource text as a training sample. That is, the server considers the sample prompt information and the corrected sample resource text as a round of dialog with the large language model. Then, the server performs training by using a plurality of training samples, so that the large language model can accurately describe the resource preference of the sample object. That is, the server trains the large language model by using a plurality of pieces of training data with prompt information. The prompt information in the present disclosure may also be referred to as a prompt word.

This embodiment of the present disclosure provides a resource recommendation method. Because positive behavior information of a target object for a resource can reflect a resource preferred by the target object, resource prompt information is constructed by using the positive behavior information, so that the resource prompt information can accurately describe a resource preference of the target object. Then, the resource prompt information is processed by using a large language model. Because the large language model has rich corpus knowledge, a resource text obtained by using the large language model can more accurately describe the resource preference of the target object. Then, a correlation between the resource text and a candidate resource in a resource library is calculated, and a resource is recommended to the target object based on a correlation between the candidate resource and the resource preference of the target object, so that the recommended resource is in line with the resource preference of the target object, thereby improving accuracy of resource recommendation. In addition, in comparison with a model link of “recall-pre-ranking-ranking-re-ranking” in a conventional recommendation system design, in this solution, recommendation can be implemented by using the positive behavior information of the target object. This can effectively shorten a recommendation link, and improves resource recommendation efficiency.

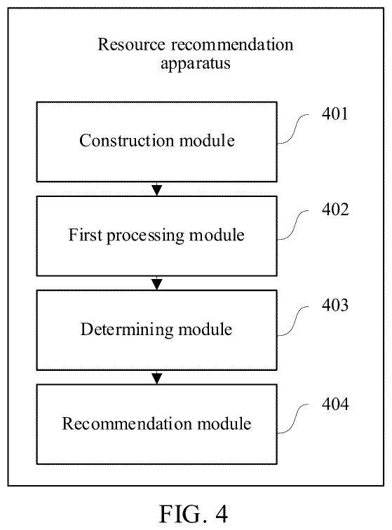

FIG. 4 is a block diagram of a resource recommendation apparatus according to an embodiment of the present disclosure. The resource recommendation apparatus is configured to perform operations in the foregoing resource recommendation method. Referring to FIG. 4, the resource recommendation apparatus includes: a construction module 401, a first processing module 402, a determining module 403, and a recommendation module 404.

The construction module 401 is configured to construct resource prompt information based on positive behavior information of a target object for a resource, the positive behavior information being configured for representing a positive behavior of the target object for a resource preference, and the resource prompt information being configured for representing a resource preferred by the target object.

The first processing module 402 is configured to process the resource prompt information by using a large language model, to obtain a resource text, the resource text being configured for describing the resource preference of the target object in a form of a natural language.

The determining module 403 is configured to determine, for any candidate resource in a resource library, a correlation between the candidate resource and the resource text, the correlation being configured for representing a correlation between the resource preference of the target object and the candidate resource.

The recommendation module 404 is configured to recommend a resource to the target object based on correlations corresponding to a plurality of candidate resources in the resource library.

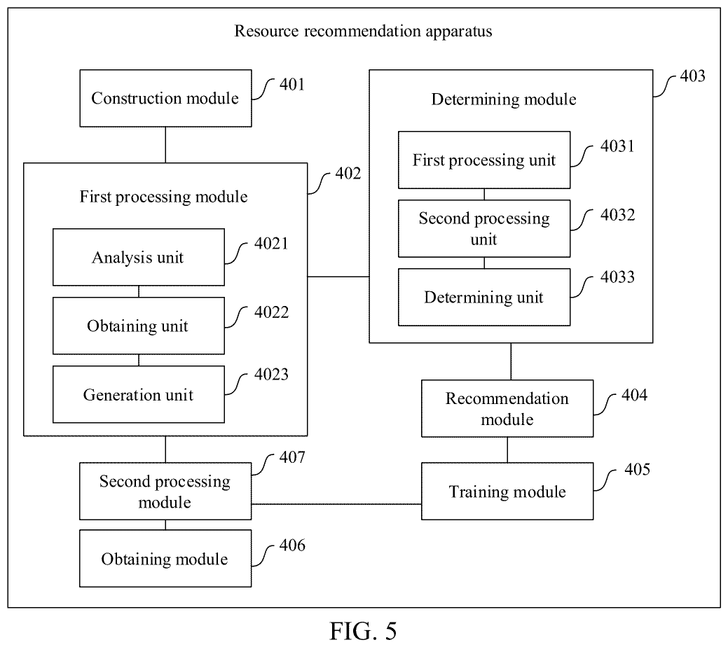

In some embodiments, FIG. 5 is a block diagram of another resource recommendation apparatus according to an embodiment of the present disclosure. Referring to FIG. 5, a construction module 401 is configured to determine at least one reference resource based on positive behavior information of a target object for a resource, the at least one reference resource being a resource for which the target object triggers a positive behavior; and construct resource prompt information based on the at least one reference resource and a recommendation requirement, the recommendation requirement being a requirement to be met for recommending a resource in a current recommendation scenario.

In some embodiments, still referring to FIG. 5, a first processing module 402 includes: an analysis unit 4021, an obtaining unit 4022, and a generation unit 4023.

The analysis unit 4021 is configured to analyze the resource prompt information by using a large language model, to determine a target resource type preferred by the target object.

The obtaining unit 4022 is configured to obtain at least one resource type related to the target resource type.

The generation unit 4023 is configured to generate a resource text based on the target resource type and the at least one resource type.

In some embodiments, still referring to FIG. 5, the obtaining unit 4022 is configured to obtain, from the current recommendation scenario based on a correlation relationship between resource types, the at least one resource type related to the target resource type.

The obtaining unit 4022 is further configured to determine, based on another recommendation scenario related to the current recommendation scenario, a resource preference of the target object in the another recommendation scenario; and obtain, from the current recommendation scenario based on the resource preference of the target object in the another recommendation scenario, the at least one resource type related to the target resource type.

In some embodiments, still referring to FIG. 5, a determining module 403 includes: a first processing unit 4031, a second processing unit 4032, and a determining unit 4033.

The first processing unit 4031 is configured to perform, for any candidate resource in a resource library, feature extraction on the candidate resource based on the large language model, to obtain a resource feature of the candidate resource, the resource feature being configured for representing detailed information of the candidate resource.

The second processing unit 4032 is configured to perform feature extraction on the resource text based on the large language model, to obtain a resource text feature.

The determining unit 4033 is configured to determine a similarity between the resource feature of the candidate resource and the resource text feature, the similarity being a correlation between the resource preference of the target object and the candidate resource.

In some embodiments, still referring to FIG. 5, the first processing unit 4031 is configured to obtain, for the any candidate resource in the resource library, text information of the candidate resource, the text information being the detailed information of the candidate resource; and perform feature extraction on the text information based on the large language model, to obtain the resource feature of the candidate resource.

In some embodiments, still referring to FIG. 5, a recommendation module 404 is configured to sort a plurality of candidate resources in the resource library in descending order of correlations; and recommend a preset quantity of top-ranked candidate resources to the target object.

In some embodiments, still referring to FIG. 5, the construction module 401 is further configured to construct sample prompt information based on positive behavior information of a sample object for a resource, the positive behavior information being configured for representing a positive behavior of the sample object for a resource preference, and the sample prompt information being configured for representing a resource preferred by the sample object.

The first processing module 402 is further configured to process the sample prompt information by using the large language model, to obtain a sample resource text, the sample resource text being configured for describing the resource preference of the sample object in a form of a natural language.

The recommendation module 404 is further configured to determine a predictive recommendation result based on the sample resource text, the predictive recommendation result being configured for representing a resource predicted by the large language model for recommendation to the sample object.

The apparatus further includes: a training module 405, configured to train the large language model based on the predictive recommendation result and a reference recommendation result, the reference recommendation result being configured for representing a resource recommended to the sample object under real circumstance.

In some embodiments, still referring to FIG. 5, the apparatus further includes: an obtaining module 406 and a second processing module 407.

The obtaining module 406 is configured to obtain the large language model obtained through training based on a language text.

The second processing module 407 is configured to keep a parameter of the large language model unchanged, and add an adjustable parameter to the large language model.

The training module 405 is configured to adjust the adjustable parameter of the large language model, to minimize a difference between the predictive recommendation result and the reference recommendation result.

This embodiment of the present disclosure provides a resource recommendation apparatus. Because positive behavior information of a target object for a resource can reflect a resource preferred by the target object, resource prompt information is constructed by using the positive behavior information, so that the resource prompt information can accurately describe a resource preference of the target object. Then, the resource prompt information is processed by using a large language model. Because the large language model has rich corpus knowledge, a resource text obtained by using the large language model can more accurately describe the resource preference of the target object. Then, a correlation between the resource text and a candidate resource in a resource library is calculated, and a resource is recommended to the target object based on a correlation between the candidate resource and the resource preference of the target object, so that the recommended resource is in line with the resource preference of the target object, thereby improving accuracy of resource recommendation.

When running an application program, the resource recommendation apparatus provided in the foregoing embodiment is illustrated only with an example of division of the foregoing function modules. In practical applications, the foregoing functions may be allocated to and completed by different function modules based on requirements. That is, an internal structure of the apparatus is divided into different function modules to complete all or some of the functions described above. In addition, the resource recommendation apparatus and the resource recommendation method embodiments provided in the foregoing embodiments belong to the same conception. For the specific implementation process, refer to the method embodiments. Details are not described herein again.

The term module (and other similar terms such as submodule, unit, subunit, etc.) in the present disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

In the embodiments of the present disclosure, a computer device can be configured as a terminal or a server. When the computer device is configured as the terminal, the terminal may be used as an execution body to implement the technical solutions provided in the embodiments of the present disclosure. When the computer device is configured as the server, the server may be used as an execution body to implement the technical solutions provided in the embodiments of the present disclosure. Alternatively, the technical solutions provided in the present disclosure can be implemented through interaction between the terminal and the server. This is not limited in the embodiments of the present disclosure.

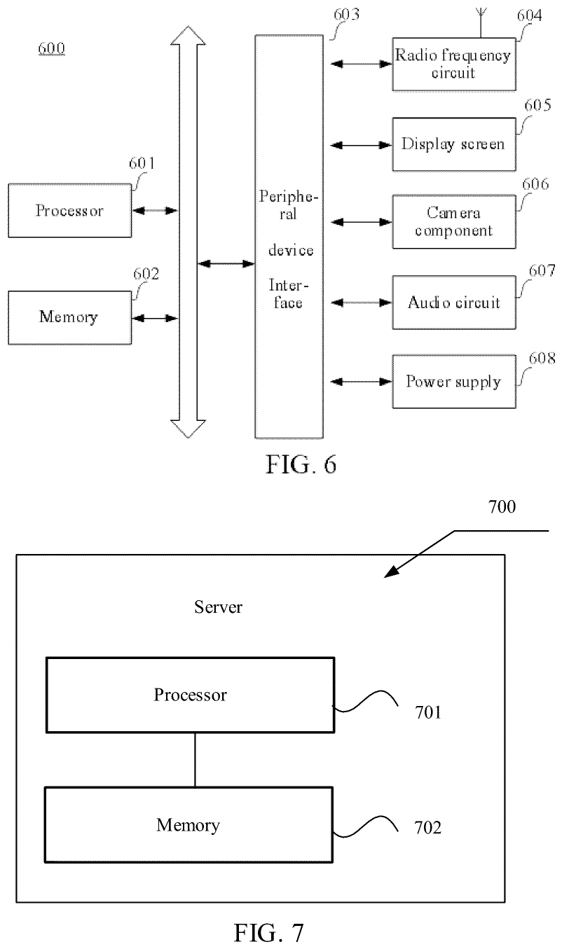

FIG. 6 is a structural block diagram of a terminal 600 according to an exemplary embodiment of the present disclosure. The terminal 600 includes a processor 601 and a memory 602.

The processor 601 may include one or more processing cores, for example, a 4-core processor or an 8-core processor. The processor 601 may be implemented by using at least one hardware form of a digital signal processor (DSP), a field-programmable gate array (FPGA), and a programmable logic array (PLA). The processor 601 may also include a main processor and a coprocessor. The main processor is a processor configured to process data in an awake state, and is also referred to as a central processing unit (CPU). The coprocessor is a low power consumption processor configured to process data in a standby state. In some embodiments, the processor 601 may be integrated with a graphics processing unit (GPU). The GPU is configured to render and draw content that needs to be displayed on a display screen. In some embodiments, the processor 601 may further include an artificial intelligence (AI) processor. The AI processor is configured to process computing operations related to machine learning.

The memory 602 may include one or more computer-readable storage media. The computer-readable storage medium may be non-transient. The memory 602 may further include a high-speed random access memory and a nonvolatile memory, for example, one or more disk storage devices or flash storage devices. In some embodiments, the non-transient computer-readable storage medium in the memory 602 is configured to store at least one computer program. The at least one computer program is configured for being executed by the processor 601 to implement the resource recommendation method provided in the method embodiments of the present disclosure.

In some embodiments, the terminal 600 may alternatively include: a peripheral device interface 603 and at least one peripheral device. The processor 601, the memory 602, and the peripheral device interface 603 may be connected through a bus or a signal wire. Each peripheral device may be connected to the peripheral device interface 603 through a bus, a signal wire, or a circuit board. Specifically, the peripheral device includes at least one of a radio frequency circuit 604, a display screen 605, a camera component 606, an audio circuit 607, and a power supply 608.

A person skilled in the art may understand that the structure shown in FIG. 6 constitutes no limitation on the terminal 600, and the terminal may include more or fewer components than those shown in the figure, or some components may be combined, or a different component deployment may be used.

FIG. 7 is a schematic structural diagram of a server according to an embodiment of the present disclosure. The server 700 may vary greatly due to different configurations or performance, and may include one or more processors (Central Processing Units, CPUs) 701 and one or more memories 702. The memory 702 stores at least one computer program. The at least one computer program is loaded and executed by the processor 701 to implement the resource recommendation method provided in the foregoing method embodiments. Certainly, the server may further include components such as a wired or wireless network interface, a keyboard, and an input/output interface, to perform input and output. The server may further include another component configured to implement a device function. Details are not described herein again.

An embodiment of the present disclosure further provides a computer-readable storage medium. The computer-readable storage medium stores at least one computer program, and the at least one computer program is loaded and executed by a processor of a computer device to implement operations performed by the computer device in the resource recommendation method in the foregoing embodiments. For example, the computer-readable storage medium may be a read-only memory (ROM), a random access memory (RAM), a compact disc read-only memory (CD-ROM), a magnetic tape, a floppy disk, an optical data storage device, or the like.

An embodiment of the present disclosure further provides a computer program product, including a computer program. The computer program is stored in a computer-readable storage medium. A processor of a computer device reads the computer program from the computer-readable storage medium, and the processor executes the computer program, to cause the computer device to perform the resource recommendation method provided in the foregoing various implementations.

A person of ordinary skill in the art may understand that all or some of the operations of the foregoing embodiments may be implemented by hardware, or may be implemented by a program instructing relevant hardware. The program may be stored in a computer-readable storage medium. The mentioned storage medium may be a read-only memory, a magnetic disk, an optical disc, or the like.

The foregoing descriptions are merely exemplary embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A resource recommendation method, performed by a computer device, comprising:
constructing resource prompt information based on positive behavior information of a target object for a resource, the positive behavior information being configured for representing a positive behavior of the target object for a resource preference, and the resource prompt information being configured for representing a resource preferred by the target object;
processing the resource prompt information by using a large language model, to obtain a resource text, the resource text being configured for describing the resource preference of the target object in a form of a natural language;
determining, for any candidate resource in a resource library for recommendations, a correlation between the candidate resource and the resource text, the correlation being configured for representing a correlation between the resource preference of the target object and the candidate resource; and
recommending a resource to the target object based on correlations corresponding to multiple candidate resources in the resource library.

2. The method according to claim 1, wherein constructing the resource prompt information based on the positive behavior information of the target object for the resource comprises:
determining at least one reference resource based on the positive behavior information of the target object for the resource, the at least one reference resource being a resource for which the target object triggers a positive behavior; and
constructing the resource prompt information based on the at least one reference resource and a recommendation requirement, the recommendation requirement being a requirement to be met for recommending a resource in a current recommendation scenario.

3. The method according to claim 1, wherein processing the resource prompt information by using the large language model, to obtain the resource text comprises:
analyzing the resource prompt information by using the large language model, to determine a target resource type preferred by the target object;
obtaining at least one resource type related to the target resource type; and
generating the resource text based on the target resource type and the at least one resource type.

4. The method according to claim 3, wherein obtaining the at least one resource type related to the target resource type comprises at least one of following:
obtaining, from the current recommendation scenario based on a correlation relationship between resource types, the at least one resource type related to the target resource type; or
determining, based on another recommendation scenario related to the current recommendation scenario, a resource preference of the target object in the another recommendation scenario; and obtaining, from the current recommendation scenario based on the resource preference of the target object in the another recommendation scenario, the at least one resource type related to the target resource type.

5. The method according to claim 1, wherein determining, for any candidate resource in the resource library for recommendations, the correlation between the candidate resource and the resource text comprises:
performing, for the any candidate resource in the resource library for recommendations, feature extraction on the candidate resource based on the large language model, to obtain a resource feature of the candidate resource, the resource feature being configured for representing detailed information of the candidate resource;
performing feature extraction on the resource text based on the large language model, to obtain a resource text feature; and
determining a similarity between the resource feature of the candidate resource and the resource text feature, the similarity being the correlation between the resource preference of the target object and the candidate resource.

6. The method according to claim 5, wherein performing, for the any candidate resource in the resource library, the feature extraction on the candidate resource based on the large language model, to obtain the resource feature of the candidate resource comprises:
obtaining, for the any candidate resource in the resource library, text information of the candidate resource, the text information being the detailed information of the candidate resource; and
performing feature extraction on the text information based on the large language model, to obtain the resource feature of the candidate resource.

7. The method according to claim 1, wherein recommending the resource to the target object based on the correlations corresponding to the multiple candidate resources in the resource library comprises:
sorting the multiple candidate resources in the resource library in descending order of the correlations; and
recommending a preset quantity of top-ranked candidate resources to the target object.

8. The method according to claim 1, wherein a training process of the large language model comprises:
constructing sample prompt information based on positive behavior information of a sample object for a resource, the positive behavior information being configured for representing a positive behavior of the sample object for a resource preference, and the sample prompt information being configured for representing a resource preferred by the sample object;
processing the sample prompt information by using the large language model, to obtain a sample resource text, the sample resource text being configured for describing the resource preference of the sample object in a form of a natural language;
determining a predictive recommendation result based on the sample resource text, the predictive recommendation result being configured for representing a resource predicted by the large language model for recommendation to the sample object; and
training the large language model based on the predictive recommendation result and a reference recommendation result, the reference recommendation result being configured for representing a resource recommended to the sample object under a real circumstance.

9. The method according to claim 8, further comprising:
obtaining the large language model obtained through training based on a language text; and
keeping a parameter of the large language model unchanged, and adding an adjustable parameter to the large language model; and
training the large language model based on the predictive recommendation result and the reference recommendation result comprises:
adjusting the adjustable parameter of the large language model, to minimize a difference between the predictive recommendation result and the reference recommendation result.

10. A computer device, comprising one or more processors and a memory containing at least one computer program that, when being executed, causes the one or more processors to perform:
constructing resource prompt information based on positive behavior information of a target object for a resource, the positive behavior information being configured for representing a positive behavior of the target object for a resource preference, and the resource prompt information being configured for representing a resource preferred by the target object;
processing the resource prompt information by using a large language model, to obtain a resource text, the resource text being configured for describing the resource preference of the target object in a form of a natural language;
determining, for any candidate resource in a resource library for recommendations, a correlation between the candidate resource and the resource text, the correlation being configured for representing a correlation between the resource preference of the target object and the candidate resource; and
recommending a resource to the target object based on correlations corresponding to multiple candidate resources in the resource library.

11. The device according to claim 10, wherein the one or more processors are further configured to perform:
determining at least one reference resource based on the positive behavior information of the target object for the resource, the at least one reference resource being a resource for which the target object triggers a positive behavior; and
constructing the resource prompt information based on the at least one reference resource and a recommendation requirement, the recommendation requirement being a requirement to be met for recommending a resource in a current recommendation scenario.

12. The device according to claim 10, wherein the one or more processors are further configured to perform:
analyzing the resource prompt information by using the large language model, to determine a target resource type preferred by the target object;
obtaining at least one resource type related to the target resource type; and
generating the resource text based on the target resource type and the at least one resource type.

13. The method according to claim 12, wherein the one or more processors are further configured to perform:
obtaining, from the current recommendation scenario based on a correlation relationship between resource types, the at least one resource type related to the target resource type; or
determining, based on another recommendation scenario related to the current recommendation scenario, a resource preference of the target object in the another recommendation scenario; and obtaining, from the current recommendation scenario based on the resource preference of the target object in the another recommendation scenario, the at least one resource type related to the target resource type.

14. The device according to claim 10, wherein the one or more processors are further configured to perform:
performing, for the any candidate resource in the resource library for recommendations, feature extraction on the candidate resource based on the large language model, to obtain a resource feature of the candidate resource, the resource feature being configured for representing detailed information of the candidate resource;
performing feature extraction on the resource text based on the large language model, to obtain a resource text feature; and
determining a similarity between the resource feature of the candidate resource and the resource text feature, the similarity being the correlation between the resource preference of the target object and the candidate resource.

15. The device according to claim 14, wherein the one or more processors are further configured to perform:
obtaining, for the any candidate resource in the resource library, text information of the candidate resource, the text information being the detailed information of the candidate resource; and
performing feature extraction on the text information based on the large language model, to obtain the resource feature of the candidate resource.

16. The device according to claim 10, wherein the one or more processors are further configured to perform:
sorting the multiple candidate resources in the resource library in descending order of the correlations; and
recommending a preset quantity of top-ranked candidate resources to the target object.

17. The device according to claim 10, wherein a training process of the large language model comprises:
constructing sample prompt information based on positive behavior information of a sample object for a resource, the positive behavior information being configured for representing a positive behavior of the sample object for a resource preference, and the sample prompt information being configured for representing a resource preferred by the sample object;
processing the sample prompt information by using the large language model, to obtain a sample resource text, the sample resource text being configured for describing the resource preference of the sample object in a form of a natural language;
determining a predictive recommendation result based on the sample resource text, the predictive recommendation result being configured for representing a resource predicted by the large language model for recommendation to the sample object; and
training the large language model based on the predictive recommendation result and a reference recommendation result, the reference recommendation result being configured for representing a resource recommended to the sample object under a real circumstance.

18. The device according to claim 17, wherein the one or more processors are further configured to perform:
obtaining the large language model obtained through training based on a language text;
keeping a parameter of the large language model unchanged, and adding an adjustable parameter to the large language model; and
adjusting the adjustable parameter of the large language model, to minimize a difference between the predictive recommendation result and the reference recommendation result.

19. A non-transitory computer-readable storage medium containing at least one computer program that, when being executed, causes at least one processor to perform:
constructing resource prompt information based on positive behavior information of a target object for a resource, the positive behavior information being configured for representing a positive behavior of the target object for a resource preference, and the resource prompt information being configured for representing a resource preferred by the target object;
processing the resource prompt information by using a large language model, to obtain a resource text, the resource text being configured for describing the resource preference of the target object in a form of a natural language;
determining, for any candidate resource in a resource library for recommendations, a correlation between the candidate resource and the resource text, the correlation being configured for representing a correlation between the resource preference of the target object and the candidate resource; and
recommending a resource to the target object based on correlations corresponding to multiple candidate resources in the resource library.

20. The storage medium according to claim 19, wherein the at least one processor is further configured to perform:
determining at least one reference resource based on the positive behavior information of the target object for the resource, the at least one reference resource being a resource for which the target object triggers a positive behavior; and
constructing the resource prompt information based on the at least one reference resource and a recommendation requirement, the recommendation requirement being a requirement to be met for recommending a resource in a current recommendation scenario.
